(19) United States
(12) Patent Application Publication
(10) Pub. No.: US 2007/0173973 A1
(43) Pub. Date: Jul. 26, 2007

(54) Sticky-footed space walking robot & gaiting method

(76) Inventor: Richard Jeffery Wagner, Torrance, CA (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/338,172

(22) Filed: Jan. 24, 2006

(51) Int. Cl. G06F 19/00

(52) U.S. Cl. 700/245

(57) ABSTRACT

A robot having three or more pairs of legs can be walked along the surface of a space vehicle in zero gravity using a pair-wise gait of the robot's feet by which a clean-lifting adhesive fixes each foot of the robot to the space vehicle's surface by a pre-load force that is less than the adhesive's pull-off force. The gait method is to opposing legs of the robot simultaneously, one pair at a time. The legs are moved and then lowered back to the vehicle's surface and forced against the vehicle surface by a pre-load force. The adhesive provides a pull-off force greater than the preload force.

### STATEMENT OF GOVERNMENT RIGHTS

This invention was made with Government support under Contract No. NNA05BE51C awarded by the NASA Ames Research Center. The government has certain rights in this invention.

### TECHNICAL FIELD

This invention relates to a robot for traversing the exterior surfaces of a space vehicle in zero gravity

### BACKGROUND

The dangers of traveling into space are evidenced by the Apollo 13 mission as well as the Challenger and Discovery disasters. Despite their inherently dangerous nature, manned space flights are almost certain to continue into the future as either a return to Earth's moon or perhaps a manned flight to Mars.

One well-known risk of space travel is the possibility that the integrity of the space vehicle's exterior surfaces can suffer damage. Damage to an exterior surface can lead to catastrophic results, as demonstrated by the “Discovery” shuttle mission.

Inspection of at least some of the shuttle's exterior surface has been made possible by way of a boom-mounted camera that delivers images of the vehicle's exterior surface to a monitor inside the vehicle. Unless the boom for a boom-mounted camera is extremely long and provided with numerous joints, a boom might not be able to reach all surfaces of a space ship as well as a person could. Those of ordinary skill in the art will recognize that as the number of joints in a boom increases, the more likely one of them is to fail, possibly rendering the boom inoperative.

Sending an astronaut outside a space vehicle to inspect the vehicle's exterior surface is not trivial. A “space walk” is inherently dangerous.

Among other things, the space suit and the astronauts who wear them must be de-pressurized and re-pressurized before and after a space walk. Every time that a suit is used, its fittings are subjected to wear, increasing the possibility of a catastrophic failure.

Carrying spare parts for a space suit means additional weight must be lifted, just to allow the suit to be used safely. Additional weight for spare parts reduces the amount of other materials that might be more useful than spare parts for a suit.

Those of ordinary skill in the art know that inspecting the surface of a space vehicle using a robot is preferable than using a boom-mounted camera or having an astronaut don a suit and venture outside the vehicle. A problem with using a robot, however, is that the robot must be able to propel itself in zero-gravity. While it is certainly possible to propel an object in space using prior art gas powered thruster/propulsion devices, controlling a robot's 3-dimensional movement with thrusters from the inside of a space vehicle would require be extremely difficult to implement and to operate. Therefore, a robot that could “walk” on the surface of a space vehicle by an attachment would be much easier to control than would a thruster-driven robot. It would obviate the need to send an astronaut and would be able to reach parts of a vehicle that would be very difficult to reach using a boom-mounted camera.

### SUMMARY

There is provided a sticky-footed, space-walking robot and a method of walking or “gaiting” the robot. The robot is capable of walking along the smooth surface of a space vehicle in zero gravity. The gaiting method provides optimum speed without having the robot’ sticky feet separate from the space vehicle's surface.

The gaiting method requires the robot to have three or more pairs of mechanical legs. At the end of each leg there is a substantially planar “foot” at the bottom of which there is applied a “sticky” adhesive, similar to the adhesives used on the nearly ubiquitous POST-IT® notes.

The sticky adhesive used on the robot feet allows the robots feet to be “removably-attached” to the surface of the space vehicle in such a way that the force required to lift a foot from the space vehicle's surface (i.e., the “pull-off force”) is greater than the force required to attach a foot to the vehicle's surface (i.e., the “pre-load force).

Gripping the surface of a space vehicle using removable adhesive or “sticky feet” requires the feet to be pre-loaded (to attach them to the space vehicle's surface) by using a compressive force and later pulled off during walking. In zero gravity, pre-loading one or more feet requires the compressive force to be supplied by a torque that is generated using both compressive and tensile loads provided through other feet.

A method for gaiting (i.e. walking) the robot is to lift opposing pairs of feet from the space vehicle's surface simultaneously. The lifted pairs of feet are moved laterally in the desired direction of travel for the robot and then lowered and the “stuck” back onto the vehicle's surface using a predetermined pre-load force.

### DESCRIPTION OF THE DRAWINGS

Features of exemplary implementations of the invention will become apparent from the description, the claims, and the accompanying drawings in which:

FIG. 1 is a plot or graph of the characteristics of an adhesive having a pull-off force that exceeds its preload force up to a limit of preload, beyond which additional preload requires no additional pull-off force;

FIG. 2 is a side view of a representation of one implementation of a space walking robot having three pairs of legs, at the end of each of which is a foot having a sticky adhesive, the preload and pull-off force of which is represented in FIG. 1;

FIG. 3 is a top view of the robot shown in FIG. 2; and

FIG. 4 is a flow chart showing steps of a gaiting method for the robot shown in FIG. 2 and FIG. 3.

### DETAILED DESCRIPTION

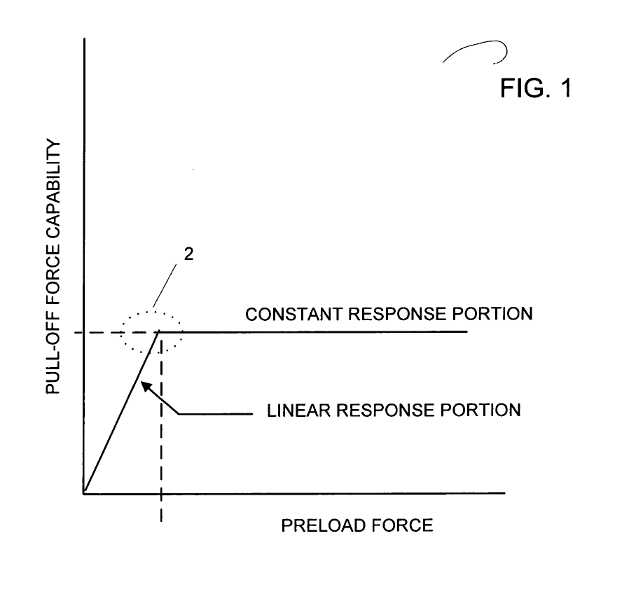

As shown in FIG. 1, some adhesives are characterized by their pull-off force being greater than their preload force up to an inflection point in the graph shown in FIG. 1, beyond which additional preload force does not yield an additional pull-off force. A well-known adhesive having the characteristics of the graph of FIG. 1 are the clean-lifting adhesives used on POST-IT® notes. The amount of force required to remove a POST-IT® from a surface can be greater than the amount of force required to apply the note, so long as the pre-load force is kept below the inflection point or “knee” identified in FIG. 1 by reference numeral 2. Silicone and polydimethysiloxane are two adhesive compounds known to have the preload /pull-off characteristics shown in FIG. 1.

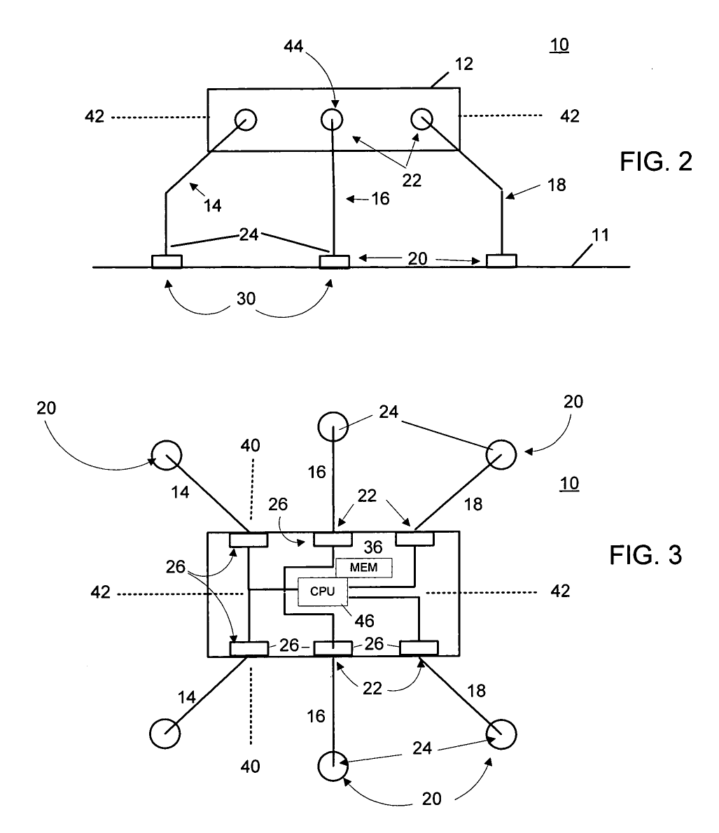

The inflection point 2 in FIG. 2 is the abscisssa value (the horizontal axis) beyond which the corresponding ordinate value (vertical axis) does not increase. In other words, as the amount of pre-load force increases above the inflection point value (i.e., the amount of force measured along the horizontal axis or abscissa) the pull-off force (amount of force measured along the vertical axis or the ordinate) remains constant. Additional preload force will not yield any greater pull off force so additional preload force is unnecessary and in the application contemplated herein, counterproductive.

An important aspect of a clean-lifting adhesive having the preload and pull-off characteristics shown in FIG. 1 is that they leave no residue on a surface they were removed from and they do not pull off of the substrate to which they are applied. That the adhesive remains attached to a substrate allows it to be repeatedly attached to and removed from a surface. Such an adhesive enables an object to be “removably attached” to a surface. By applying a clean-lifting adhesive, having preload and pull-off force characteristics shown in FIG. 1, to the feet of a walking robot, a robot can be made to “walk” across even a smooth surface of a space vehicle in zero gravity.

As used hereinafter, the term “preload force” of an adhesive refers to the amount of force exerted against the foot of a robot, the bottom surface of which carries an adhesive having the characteristics shown in (or at least similar to) FIG. 1. “Pull-off” force means the amount of force required to separate the robot foot that was attached to a surface using a particular preload force.

Key to a sticky-footed robot's ability to walk over the smooth surface of a space vehicle, however, is the necessity of controlling the feet movement so that the pre-load force applied to feet after they have been laterally moved, is just enough to yield a maximum pull-off force. Because the robot needs to be able to propel itself in zero gravity, preload force applied to each foot must be supplied from torque around an axis that is derived from pull-off force of other feet. Too much pre-load force at one foot can cause all of the other feet to separate from the space vehicle's surface, allowing the robot to drift into space.

Turning now to FIG. 2 and FIG. 3 there is a robot 10 designed to be capable of moving along the surface of a space craft in zero gravity. FIG. 2 is a side view of the robot 10 on a surface 11. FIG. 3 is a top view of the robot 10, which shows the robot's body 12 to be rectangular, however, the robot's body geometry is not germane to the embodiments of the invention disclosed and claimed herein and virtually any robot body shaped could be used with the pair-wise method of gaiting a robot across a space vehicle's surface using sticky-feet.

The robot 10 is comprised of a body 12, from which there extend at least three pairs of mechanically-driven opposing legs 14, 16 and 18. Each leg has an end that is close to the robot body and which is referred to herein as the leg's proximal end 22. The proximal end 22 of each leg is coupled to a lifting mechanism 26 which can raise and lower a corresponding leg in response to signals sent to a lifting mechanism 26 from a central controller 34 in the robot body 12.

The end of each leg furthest away from the robot body 12 is referred to herein as the leg's distal end 24. As shown in FIGS. 1 and 2, a foot 20 is attached to the leg's distal end 24.

As best seen in FIG. 2, each foot has a substantially planar bottom surface 30 to which an adhesive with the characteristics shown in FIG. 1 is applied. Since the adhesive described above is applied to the bottom surface 30 of each foot 20, the bottom surface 30 is also considered to be a “contact surface” because it is the surface that makes contact with the surface of a space vehicle as the robot gaits or walks.

An important feature of the robot 10 that enables the gaiting method disclosed herein is that the legs are arranged in “opposing pairs.” The pairs of legs are identified by reference numerals 14, 16 and 18. The pairing of the legs such that they are “opposing” is explained by way of example.

Each leg has an end that is close to or adjacent to the robot body 12 and which is mechanically connected to a mechanical lifting mechanism 26. The lifting mechanism raises, lowers and rotates a corresponding leg in response to control signals from a computer/controller 46. The proximal end of each the leg is identified by reference numeral 22.

With regard to the first pair of legs which are identified reference numeral 14, the proximal ends 22 of these legs lie on a first axis represented by a broken line identified by reference numeral 40. This first axis 40 is orthogonal to a second axis, which is also represented by a broken line and identified by reference numeral 42. The second axis 42 is an axis of symmetry for the robot body 12 and it runs through the centroid of the robot body's footprint or center of stance. By locating the two legs of leg pair 14 directly opposite to each other on the first axis 40, equal forces applied to a space vehicle's surface through the legs 14 will not cause the robot body 12 to rotate around the second axis of symmetry 42, so long as the forces are equal and the legs of the same length and the same distance away from the second axis of symmetry.

A second pair of opposing legs that operate like the first pair 14, is identified by reference numeral 16. A third pair of opposing legs is identified by reference numeral 18. When the first pair of legs 14 is being lifted and lowered by the corresponding lifting mechanisms 26, the second and third pairs of legs 16 and 18 respectively are in tension and compression in order to oppose the forces created by movement of the first pair of legs against the adhesive or the space vehicle's surface.

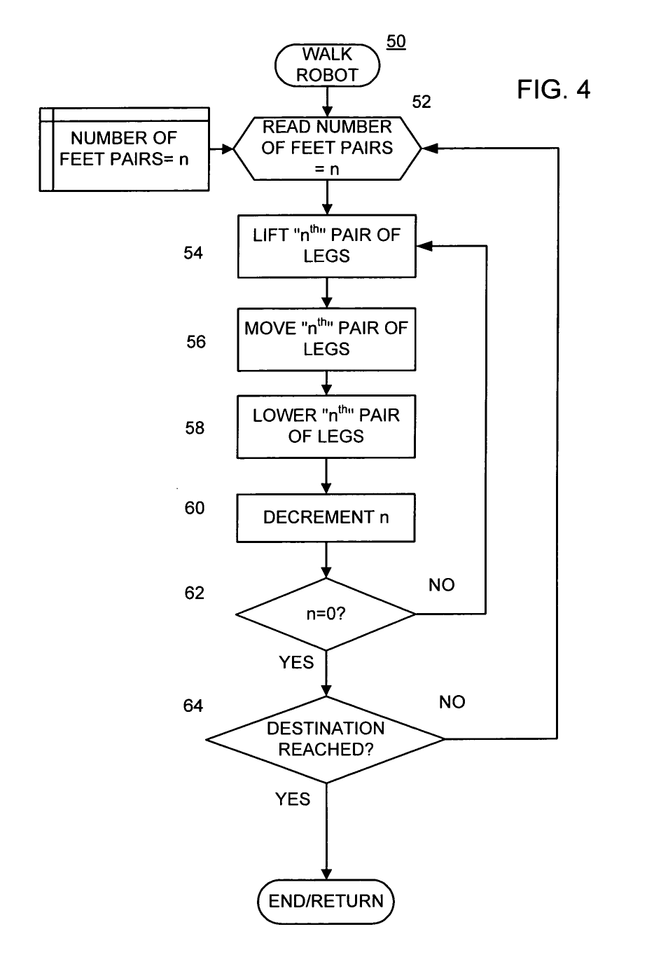

As with the first pair of legs 14, the legs of the second and third pairs are each connected to their own mechanical lifting mechanism 26, each of which is coupled to the CPU 46. Program instructions that are stored in a memory device 48 coupled to the CPU 46 cause the lifting mechanisms 26 to move the leg pairs 14, 16 and 18 one at a time according to the steps shown in FIG. 4.

FIG. 4 depicts the steps of a method 50 for gaiting the robot 10 along the surface of a space vehicle in zero gravity. The method presumes that the robot 10 has been already placed onto a surface by a compressive preload force just below the inflection point value shown in FIG. 1.

In step 52, the number of feet pairs is read by the CPU 46 (at least once on power up). As the method is implemented in FIG. 4, the value of the number of feet pairs read in step 52 is used as a loop counter. The loop counter is then decremented at the completion of each pass through the loop until the loop counter value is zeroed.

In step 54, the first of “n” pair of legs is lifted from the space vehicle's surface under the control of the CPU. It is important that the legs that comprise each pair of legs be lifted simultaneously to prevent the robot body 12 from being rotated around the second axis 42.

In step 56, the first pair of opposing legs is controlled by the CPU to move the feet of the legs by a first lateral distance in a desired direction of travel for the robot. After the legs are moved laterally, they're lowered back to the space vehicle's surface in step 58.

When the legs are lowered to the space vehicle's surface, it is important that they be lowered simultaneously and that they be lowered with equal preload forces. In order to obtain the maximum amount of pull-off force from the adhesive on the feet 20, it is important that the preload force be just below the preload force of the inflection point 2 shown in FIG. 1.

Still referring to FIG. 4, after the first pair of legs are lowered to the space vehicle's surface, the loop counter “n” is decremented in step 60 and a loop counter limit test performed in step 62. If the loop counter “n” is not zero, program control returns to step 54 where the next pair of legs is moved using steps 54 through 60.

When the loop counter “n” reaches zero, all leg pairs have been moved and a second test performed in step 64 where a determination is made as to whether the robot 10 reached its destination. If not, program control returns to step 52 where the loop counter is re-initialized and the leg pairs are all moved again.

Those of skill in the art will recognize that the adhesive's characteristics are critical but the precise composition of the adhesive is not critical so long as the adhesive's preload and pull-off loads are substantially consistent with FIG. 1. Most such adhesives will be a polymeric compound.

The method steps described herein are steps of just one embodiment. There may be many variations to these steps or operations without departing from the spirit of the invention. For instance, the leg pairs may be moved in a differing order, or steps may be added, deleted, or modified. Operations other than traversing are also covered, including turning while walking, turning in place, testing the grip of the robot for long duration standing etc.

Those of ordinary skill in the art will recognize that the method and apparatus described above inherently presumes that the robot body is held or fixed at an elevation above the space craft's surface by the legs that are not moved while a pair of legs is lifted and lowered under the control of a computer. In another embodiment, the pairs of legs that are to be “lifted” and “lowered” as described above, could instead be held fixed while the robot's other legs are all extended or retracted so as to lifted and/or lower the robot's body with respect to the space craft surface.

For example, if a robot has three pairs of legs, causing two of the three pairs of opposing legs to simultaneously raise the robot body away from the space craft's surface would eventually cause the adhesive on the feet of the third pair of legs to separate from the space craft surface. After the feet of the third pair of legs is separated from the space craft's surface, the third pair of legs could be laterally moved in a direction of travel. By lowering or contracting the first two pairs of legs, they can bring the feet of the third pair of legs back into contact with the space craft surface. In such an embodiment, the two pairs of legs will, in effect, caused a separation force to be applied to the adhesive on the third pair of legs. They will also cause a preload force to be applied.

In light of the foregoing, for purposes of this disclosure and the claims appended hereto, the terms and concepts of “lift” “raise” “lifting” and/or “raising” should be understood to mean that a leg or foot and/or its corresponding adhesive is separated or detached away from the space craft's surface, whether it is by controlled movement of that leg or foot or, by the controlled movement of the other legs and/or feet of the robot. Similarly, the terms and concepts of “lowering” simply means that a leg or foot and/or its corresponding adhesive is caused to be brought toward and/or into contact with the space craft surface, whether it is by that leg or foot or by the other legs and/or feet of the robot.

The robot depicted in the figures and the number of legs it has is also just one embodiment. While the method requires at least three pairs of legs, the method and hence the robot 10 could be constructed using four or more pairs of legs without departing from the spirit of the subject matter claimed in the following claims.

What is claimed is:

1. A gaiting method for moving a robot along the surface of a space vehicle in zero gravity, the method comprising the steps of:
lifting a first pair of opposing legs from the vehicle surface to detach a contact surface of each corresponding foot from the vehicle's surface;
laterally moving said first pair of opposing legs by a first lateral distance in a desired direction of travel for said robot; and
lowering said first pair of opposing legs toward the vehicle surface to cause an adhesive on the contact surface of each surface to be forced against the vehicle surface by a pre-load force.

2. A gaiting method for moving a robot along the surface of a space vehicle in zero gravity, the robot having a body from which extend at least three pairs of opposing legs, the distal end of each leg having a foot that is removably affixed to the vehicle's surface using an adhesive on a vehicle contact surface of each foot, said adhesive fixing each foot to the surface by a pre-load force that is less than the adhesive's pull-off force, said gait method comprised of the step of:
lifting a first pair of opposing legs from the vehicle surface to detach the contact surface of each corresponding foot from the vehicle's surface;
laterally moving said first pair of opposing legs by a first lateral distance in a desired direction of travel for said robot; and
lowering said first pair of opposing legs toward the vehicle surface to cause adhesive on the contact surface of each surface to be forced against the vehicle surface by said pre-load force.

3. The method of claim 1 wherein the step of lifting said first pair of opposing legs is further comprises the step of lifting said first pair of legs simultaneously.

4. The method of claim 1 wherein the step of lowering said first pair of opposing legs is further comprised of the step of lowering said first pair of opposing legs simultaneously.

5. The method of claim 1 further comprising the steps of:
lifting a second pair of opposing legs from the vehicle surface to detach the contact surface of each corresponding foot from the vehicle's surface;
laterally moving said second pair of opposing legs by a first lateral distance in a desired direction of travel for said robot; and
lowering said second pair of opposing legs toward the vehicle surface to cause adhesive on the contact surface of each surface to be forced against the vehicle surface by said pre-load force.
after steps 1a, 1b and 1c have completed.

6. The method of claim 5 further comprising the steps of:
lifting a third pair of opposing legs from the vehicle surface to detach the contact surface of each corresponding foot from the vehicle's surface;
laterally moving said third pair of opposing legs by a first lateral distance in a desired direction of travel for said robot; and
lowering said third pair of opposing legs toward the vehicle surface to cause adhesive on the contact surface of each surface to be forced against the vehicle surface by said pre-load force.
after steps 5d, 5e and 5f have completed.

7. The method of claim 1 wherein said adhesive provides a pull-off force linearly proportional to the adhesive's preload force up to a first amount of preload force, above which the pull-off force of the adhesive is substantially constant.

8. The method of claim 1 wherein said adhesive provides a pull-off force for each foot that is at least twice as great as each foot's preload force.

9. The method of claim 1 wherein said adhesive is a polymeric compound.

10. The method of claim 1 wherein said adhesive is one of silicone and polydimethysiloxane.

11. A robot capable of moving along the surface of a space craft in zero gravity comprised of:
a body;
at least three pairs of opposing legs extending from said robot body; each leg having a foot that contacts the space craft's surface, each leg being coupled to a lifting mechanism that raises and lowers legs in response to a control signal;
adhesive on the foot of each leg that removably attaches each foot to the space craft surface such that said adhesive requires a predetermined pull-off force to detach the foot from the space craft surface, after said adhesive has been pressed against the space craft surface with a pre-load force;
a controller, operatively coupled to each lifting mechanism; and
a computer storage media operatively coupled to said controller, said storage media storing computer program instructions, which when they are executed cause the controller to send a signal to said lifting mechanism to cause the lifting mechanism to:
lift a first pair of opposing legs from the vehicle surface; and
lower said first pair of opposing legs to the vehicle surface and exert said pre-load force on said adhesive.

12. A robot capable of moving along the surface of a space craft in zero gravity comprised of:
a body;
at least three pairs of opposing legs extending from said robot body; each leg having a foot located at the leg's distal end, each leg being coupled to a lifting mechanism that exerts upward and downward forces on each leg by which each leg is raised and lowered in response to a control signal;
adhesive on each foot that removably attaches each foot to the space craft surface such that said foot requires a predetermined pull-off force to be detached from the space craft surface, after said foot has been pressed against the space craft surface with a pre-load force that is less than the pull-off force;
a controller, operatively coupled to each lifting mechanism; and a computer storage media operatively coupled to said controller, said storage media storing computer program instructions, which when they are executed cause the controller to:
send a signal to the lifting mechanism that causes the lifting mechanism to lift a first pair of opposing legs from the vehicle surface;
send a signal to the lifting mechanism that causes the lifting mechanism to move said first pair of opposing legs in a desired direction of travel for said robot; and
send a signal to the lifting mechanism that causes the lifting mechanism to lower said first pair of opposing legs to the vehicle surface.

13. The robot of claim 11 wherein said body has a centroid and an axis of symmetry extending through the centroid and wherein each pair of legs lies on a second axis that is orthogonal to the axis of symmetry.

14. The robot of claim 11 wherein the storage media stores computer program instructions that cause the controller to lift pairs of opposing legs from the vehicle surface simultaneously.

15. The robot of claim 11 wherein the storage media stores computer program instructions that cause the controller to:
lift a second pair of opposing legs from the vehicle surface; and
lower said second pair of opposing legs toward the vehicle surface to cause adhesive to be forced against the vehicle surface by said pre-load force.

16. The robot of claim 11 wherein the storage media stored computer program instructions that cause the controller to:
lift a third pair of opposing legs from the vehicle surface; and
lower said third pair of opposing legs toward the vehicle surface to cause adhesive to be forced against the vehicle surface by said pre-load force.

17. The robot of claim 11, wherein said adhesive is one that has a pull-off force generally greater than the preload force required to effect adhesion.

18. The robot of claim 11 wherein said adhesive is one that provides a pull-off force linearly proportional to the adhesive's preload force up to a first amount of preload force, above which the pull-off force of the adhesive is constant.

19. The robot of claim 11 wherein said adhesive is one that provides a pull-off force for each foot that is at least twice as great as each foot's preload force.

20. The robot of claim 11 wherein said adhesive is a polymeric compound.

21. The robot of claim 11 wherein said adhesive is one of silicone and polydimethysiloxane.

22. A robot capable of moving along the surface of a space craft in zero gravity comprised of:
a body;
at least three pairs of opposing legs extending from said robot body; each leg having a foot located at the leg's distal end, each leg being coupled to a lifting mechanism that exerts upward and downward forces on each leg by which each leg is raised and lowered in response to a control signal;
adhesive on each foot that removably attaches each foot to the space craft surface such that said foot requires a predetermined pull-off force to be detached from the space craft surface, after said foot has been pressed against the space craft surface with a pre-load force that is less than the pull-off force;
a controller, operatively coupled to each lifting mechanism; and
a computer storage media operatively coupled to said controller, said storage media storing computer program instructions, which when they are executed cause the controller to:
send a signal to the lifting mechanism that causes the lifting mechanism to lift a first pair of opposing legs from the vehicle surface;
send a signal to the lifting mechanism that causes the lifting mechanism to move said first pair of opposing legs in a desired direction of travel for said robot; and
send a signal to the lifting mechanism that causes the lifting mechanism to lower said first pair of opposing legs to the vehicle surface.
